(19) United States
(12) Patent Application Publication
(10) Pub. No.: US 2016/0335327 A1
(43) Pub. Date: Nov. 17, 2016

(54) Context Aware Suggestion

(71) Applicant: HCL Technologies Limited, Uttar Pradesh (IN)

(72) Inventors: Satya Sai Prakash Kanakadandi, Andhra Pradesh (IN); S U M Prasad Dhanyamraju, Andhra Pradesh (IN)

(21) Appl. No.: 15/074,179

(22) Filed: Mar. 18, 2016

(30) Foreign Application Priority Data
May 15, 2015 (IN) 1363/DEL/2015

(51) Int. Cl. G06F 17/30; G06N 99/00

(52) U.S. Cl. CPC G06F 17/30554; G06F 17/3033; G06F 17/30528; G06F 17/30867; G06N 99/005

(57) ABSTRACT

Disclosed is a method and system for providing a context aware suggestion. In one aspect, the method comprises generating one or more hash indexes associated with a primary user based on primary user data and generating a hash matrix associated to the primary user based on the primary user data, one or more secondary users associated to the primary user data, and the one or more hash indexes. The method further comprises, developing a master list based on the one or more hash indexes and creating a primary user persona associated to the primary user based on the master list and organization data. The method furthermore comprise providing a context aware suggestion to the primary user in response to a text input from the primary user, wherein the context aware suggestion is based on the primary user persona and the hash matrix.

### CROSS-REFERENCE TO RELATED APPLICATIONS AND PRIORITY

The present application claims benefit from Indian Complete Patent Application Number 1363/DEL/2015, filed on 15 May 2015, the entirety of which is hereby incorporated by reference.

### TECHNICAL FIELD

The present subject matter described herein, in general, relates to a system and a method for providing a suggestion to a user, and more particularly a system and a method for providing a context aware suggestion in an organization to a user.

### BACKGROUND

Generally, users of any computing devices are becoming more and more accustomed to being able to obtain instant access to information. The information that can be obtained may include information on almost any subject of interest to the user. Typically, a user may access such information by performing a search which may include one or more keywords that are entered. For example, if a visitor to the search engine website enters the term “flowers,” web sites that may be relevant to flowers are displayed. Typically, user may recognize that a vast amount of information is available, but may be unfamiliar with the searches or the keywords that need to be performed to locate useful information. Conventionally, an auto suggests feature is utilized by various websites to support user searching.

The auto suggest is also a common feature in most of the text box based applications, such as browser address bar, email To/CC/Subject/Attachment fields and typical search bar on many websites used to assist a user. Conventional, auto suggests methods include simple pre-population of a database results and advanced predictive word suggestion programs and algorithms. Other typical techniques for auto suggest include historical data sorted by most recently used algorithms, most frequently used algorithms, dictionary ordering and book mark based priority rating. But such conventional techniques fail when implemented inside to an organization, due to various restrictions implemented on a user based on the organization policy for example, confidential data policy, information technology policy, human recourse policy and other organization data. The failure of such conventional techniques inside an organization may also be attributed to their lack of contextual awareness of the suggestion.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular implementations or versions or embodiments only, and is not intended to limit the scope of the present application. This summary is provided to introduce aspects related to a system and a method for providing a context aware suggestion. This summary is not intended to identify essential features of the claimed subject matter nor is it intended for use in determining or limiting the scope of the claimed subject matter.

In one implementation, a system for providing a context aware suggestion is disclosed. In one aspect, the system may generate one or more hash indexes associated with a primary user based on primary user data. Further, the system may generate a hash matrix associated to the primary user based on the primary user data, one or more secondary users associated to the primary user data, and the one or more hash indexes, and wherein the hash matrix is a two dimensional matrix. Upon generation, the system may develop a master list based on the one or more hash indexes. Further to developing, the system may create a primary user persona associated to the primary user based on the master list and organization data. Subsequently, the system may provide a context aware suggestion to the primary user in response to a text input from the primary user, wherein the context aware suggestion is based on the primary user persona and the hash matrix.

In another implementation, a method for providing a context aware suggestion is disclosed. In one aspect, the method may comprise generating one or more hash indexes associated with a primary user based on primary user data and generating a hash matrix associated to the primary user based on the primary user data, one or more secondary users associated to the primary user data, and the one or more hash indexes, and wherein the hash matrix is a two dimensional matrix. The method may further comprise, developing a master list based on the one or more hash indexes and creating a primary user persona associated to the primary user based on the master list and organization data. The method may further more comprise providing a context aware suggestion to the primary user in response to a text input from the primary user, wherein the context aware suggestion is based on the primary user persona and the hash matrix.

In yet another implementation, non-transitory computer readable medium embodying a program executable in a computing device for providing a context aware suggestion is disclosed. The program may comprise a program code for generating one or more hash indexes associated with a primary user based on primary user data. Further, the program may comprise a program code for generating a hash matrix associated to the primary user based on the primary user data, one or more secondary users associated to the primary user data, and the one or more hash indexes, and wherein the hash matrix is a two dimensional matrix. Furthermore, the program may comprise a program code for developing a master list based on the one or more hash indexes. The program may also comprise a program code for creating a primary user persona associated to the primary user based on the master list and organization data. The program may further comprise a program code for providing a context aware suggestion to the primary user in response to a text input from the primary user, wherein the context aware suggestion is based on the primary user persona and the hash matrix.

### BRIEF DESCRIPTION OF THE DRAWINGS

The foregoing detailed description of embodiments is better understood when read in conjunction with the appended drawings. For the purpose of illustrating of the present subject matter, an example of construction of the present subject matter is provided as figures; however, the invention is not limited to the specific method and system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a system for providing a context aware suggestion, in accordance with an embodiment of the present subject matter.

FIG. 2 illustrates the system, in accordance with an embodiment of the present subject matter.

FIG. 3 illustrates a method for providing a context aware suggestion, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely examples of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments described, but is to be accorded the widest scope consistent with the principles and features described herein.

In an implementation, a system and method for providing a context aware suggestion, is described. In the implementation, organization data, primary user data and a text input may be obtained. In an example the text input may be obtained for the primary user. The organization data may be obtained from organizational repository. The primary user data may be obtained from the user device and organizational repository. The primary user data may comprise a primary user document, a primary user chat transcript, a primary user email, a primary user calendar notification, an primary user notes pointers and a primary user activity data. The organization data may comprise organizational policies, an organizational structure, an organizational role, organizational responsibilities, a project assignations and a people graph.

In the implementation upon obtaining, one or more hash indexes associated with the primary user may be generated, based on the primary user data. Further, a hash matrix associated to the primary user may be generated based on the primary user data, one or more secondary users associated to the primary user data, and the one or more hash indexes. In an example, the hash matrix is a two dimensional matrix. Subsequent to the generating, a master list based on the one or more hash indexes may be developed. Further to developing, a primary user persona associated to the primary user may be created, based on the master list and organization data. Upon creating the primary user persona, a context aware suggestion to the primary user is provided. The context aware suggestion is based on the primary user persona and the hash matrix. The context aware suggestion may be provided in response to a text input from the primary user.

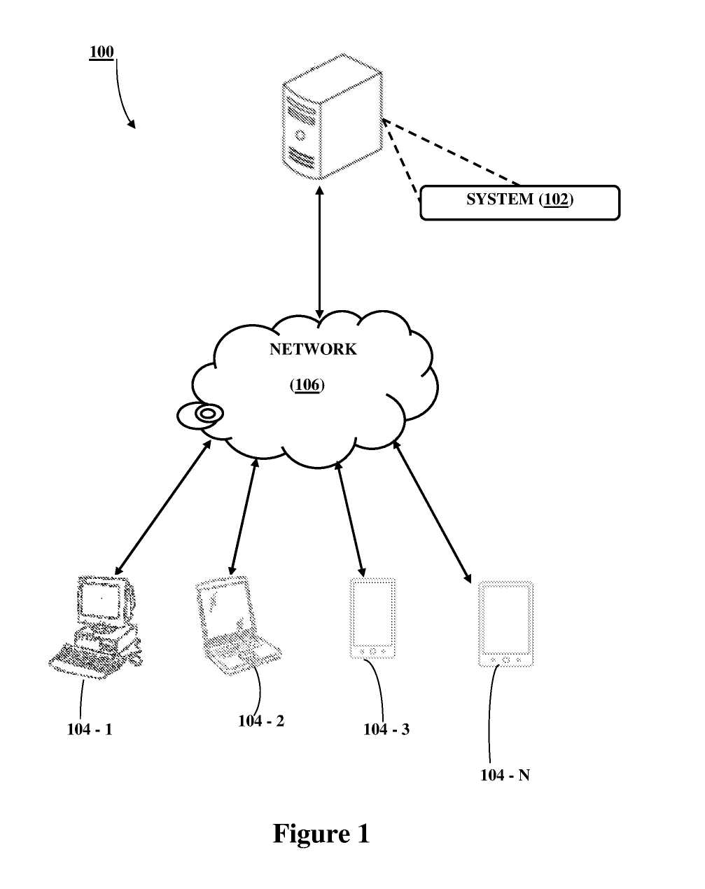

Referring now to FIG. 1, a network implementation of a system 102 for providing a context aware suggestion, in accordance with an embodiment of the present subject matter may be described. In one embodiment, the present subject matter is explained considering that the system 102 may be implemented as a standalone system connects to a network. It may be understood that the system 102 may also be implemented in a variety of computing systems, such as a laptop computer, a desktop computer, a notebook, a workstation, a mainframe computer, a server, a network server, a cloud-based computing environment and the like.

In one implementation, the system 102 may comprise the cloud-based computing environment in which the user may operate individual computing systems configured to execute remotely located applications. In another embodiment, the system 102 may also be implemented on a client device hereinafter referred to as a user device 104. It may be understood that the system implemented on the client device supports a plurality of browsers and all viewports. Examples of the plurality of browsers may include, but not limited to, Chrome™, Mozilla™, Internet Explorer™, Safari™, and Opera™. It will also be understood that the system 102 may be accessed by multiple users through one or more user devices 104-1, 104-2 . . . and 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

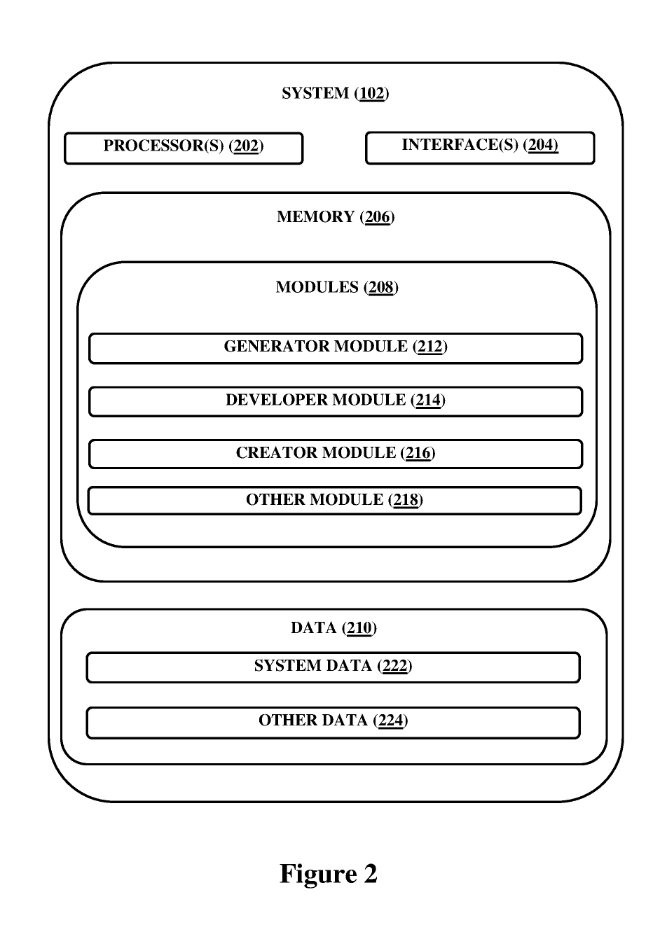

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a generator module 212, a developer module 214, a creator module 216 and an other module 218. The other modules 218 may include programs or coded instructions that supplement applications and functions of the system 102. The modules 208 described herein may be implemented as software modules that may be executed in the cloud-based computing environment of the system 102.

The memory 206, amongst other things, serves as a repository for storing data processed, received, and generated by one or more of the modules 208. The memory 206 may include data generated as a result of the execution of one or more modules in the other module 220. In one implementation, the memory may include data 210. Further, the data 210 may include a system data 222 for storing data processed, received, and generated by one or more of the modules 208. Furthermore, the data 210 may include other data 224 for storing data generated as a result of the execution of one or more modules in the other module 220.

In one implementation, at first, a user may use the client device 104 to access the system 102 via the I/O interface 204. The user may register them using the I/O interface 204 in order to use the system 102. In one aspect, the user may access the I/O interface 204 of the system 102 for providing a context aware suggestion.

### Generator Module 212

Referring to FIG. 2, in an implementation, a system and method for providing a context aware suggestion, is described. In the implementation, the generator module 212 may obtain organization data, primary user data and a text input.

The organization data may comprise organizational policies, organizational structure, organizational roles and responsibilities, a project assignations and a people graph. In example, organizational policies may comprises human resource policies, confidential data policy, information technology policy and like. Organizational structure may be understood as information on grouping and consolidating organization functions. For example, an organization structure may comprise data on various departments within an organization and the hierarchy. Hierarchy may be understood as the information that helps make clear who answers to whom and where they fit in the chain of command For example, the hierarchy may have a director who reports to a vice president who in turn reports to a chief executive officer who reports to a board of directors or company owner. In one implementation organizational roles and responsibilities may comprise information on the entire employee and consultants' role within the organization and their responsibilities. The people graph may be understood a diagrammatic representation of an employee describing the complete information of the employee.

The primary user data may comprise a primary user document, a primary user chat transcript, a primary user email, a primary user calendar notification, a primary user notes and a primary user activity data. The text input may be obtained from the primary user. In one more example the user may be using a browser or an email client. Further, the user may type a text input in the browser address bar, search and/or email address boxes. Subsequently, the text input may be obtained to provide a context aware suggestion to the user. In the example, the text input may be alphabet, a word, a number or like, for which a context aware suggestion may be provided to the user. In one example the text input may be lists of suggesting generated utilizing a conventional auto suggest process.

In the implementation upon obtaining, the generator module 212 may generate hash indexes associated with the primary user based on the primary user data. In one example hash indexes may be generated for each of the primary user document, the primary user chat transcript, the primary user email, the primary user calendar notification, the primary user notes pointers and the primary user activity data. Further, the generator module 212 may generate a hash matrix. The hash matrix may be associated to the primary user data, one or more secondary users associated to the primary user data, and the one or more hash indexes. The hash matrix may be a two dimensional matrix. In an example, the hash matrix may be a correlation between primary user activity and secondary users. In one more example, the hash matrix may include the correlation of a primary user activity of a meeting request with multiple secondary users.

In the implementation, the generator module 212 may generate the hash index and hash matrix at a predefined time interval. In one example, the predefined time interval may be configurable. In one other implementation, the generator module 212 may store organization data, primary user data, a text input, hash indexes and hash matrix in system data 222.

### Developer Module 214

In the embodiment, subsequent to the generating, the developer module 214 may develop a master list based on the hash indexes. In one example, the master list may comprise of unique and distinct key word list. In the implementation, the developer module 214 may develop the master list at a predefined first time interval. In one example, the predefined first time interval may be configurable. In one more example, the developing of the master list at the predefined first time interval may be a daemon process. The daemon process may be understood as a computer program that runs as a background process, rather than being under the direct control of an interactive user. In one other implementation, the developer module 214 may store the master list in system data 222.

### Creator Module 216

In the implementation, further to developing, the creator module 216 may create a primary user persona associated to the primary user. The primary user persona is based on the master list and organization data. In an example, the mater list may be correlated with the organizational data for creating the primary user persona. The primary user persona may be understood as a unique transactional signature of the primary user in the digital space of the organization. In the implementation, the creator module 216 may develop the primary user persona at a predefined second time interval. In one example, the predefined second time interval may be configurable.

Upon creating, the creator module 216 may provide a context aware suggestion to the primary user. In an example, the providing may be in response to the text input from the primary user. Further, the context aware suggestion is based on the primary user persona and the hash matrix. Further, the context aware suggestion may be understood as a specific combination of word used as well as recommended based on the situational awareness. In the example, the context aware suggestion may be an organizational context aware suggestion. In one implementation, the text input comprising one or more suggestions developed using convention methods may be reordered based on the primary user persona and hash matrix and provided to the primary user

In one other implementation, the creator module 216 may store the primary user persona, and the context aware suggestion in system data 222.

In one implementation, a machine learning technique may be utilized for improving the accuracy of the context aware suggestion. Machine learning technique may be understood as algorithms that enable a computer like machine to automatically process the data and make human like inferences based on surrounding information and situation/context. In an example the machine learning technique may be a semi-supervised machine learning technique. In one more example, the machine learning technique may be a reinforcement machine learning technique. In the reinforcement machine learning technique, every positive acceptance of the context aware suggestion by the primary user enables reinforcement and the system's learning strengthens. Further, reinforcement machine learning technique may be based on local as well as global scoring method, which is central to an organization. Further, such scoring method may normalize individual biases over a period of time and increase the accuracy of context aware suggestion.

Exemplary embodiments discussed above may provide certain advantages. Though not required to practice aspects of the disclosure, these advantages may include those provided by the following features.

Some embodiments enable the system and the method to identify the precise text for the first time users.

Some embodiments enable the system and the method to reduce the time required for searching.

Some embodiments enable the system and the method to reduce the time required for e-mailing

Some embodiments enable the system and the method to provide user specific suggestion

Some embodiments enable the system and the method to provide automatic suggestion.

Some embodiments enable the system and the method to provide a context aware suggestion within an organization.

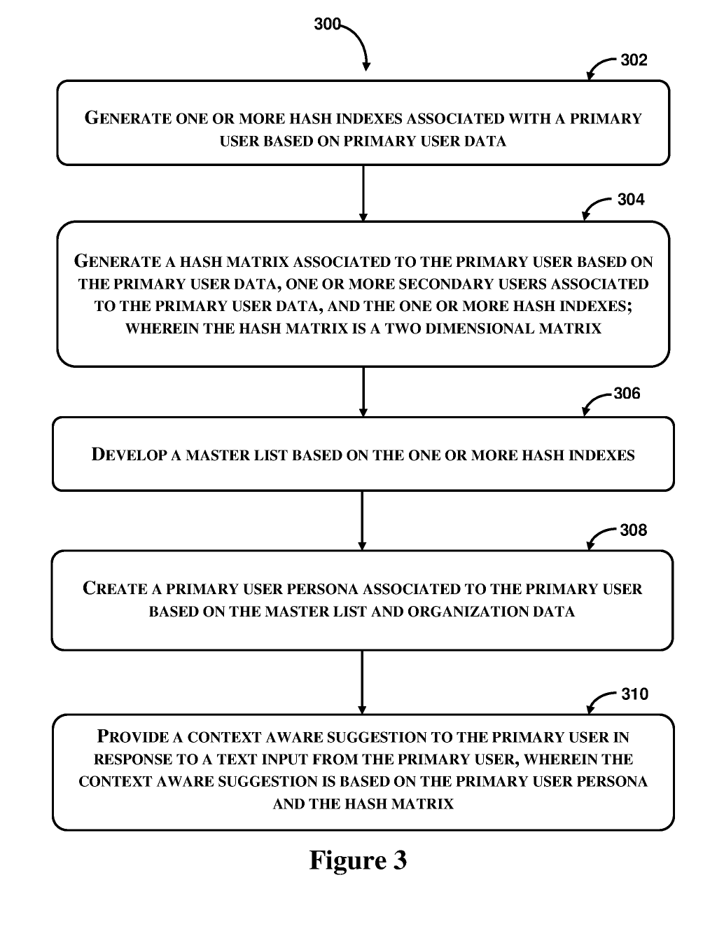

Referring now to FIG. 3, a method 300 for providing a context aware suggestion is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, one or more hash indexes associated with a primary user based on primary user data is generated. In an implementation, the generator module 212 may generate one or more hash indexes associated with a primary user based on primary user data and store one or more hash indexes in system data 222.

At block 304, a hash matrix associated to the primary user based on the primary user data, one or more secondary users associated to the primary user data, and the one or more hash indexes is generated. Further, the hash matrix is a two dimensional matrix. In the implementation, the generator module 212 may generate a hash matrix associated to the primary user based on the primary user data, one or more secondary users associated to the primary user data, and the one or more hash indexes and store the hash matrix in system data 222.

At block 306, a master list based on the one or more hash indexes is developed. In the implementation, the developer module 214 may develop a master list based on the one or more hash indexes and store the master list in system data 222.

At block 308, a primary user persona associated to the primary user based on the master list and organization data is created. In the implementation, the creator module 216 may create a primary user persona associated to the primary user based on the master list and organization data and store the primary user persona in system data 222.

At block 310, a context aware suggestion to the primary user in response to a text input from the primary user is provided. Further, the context aware suggestion is based on the primary user persona and the hash matrix. In the implementation, the creator module 216 may provide a context aware suggestion to the primary user in response to a text input from the primary user and also store the context aware suggestion in system data 222.

Exemplary embodiments discussed above may provide certain advantages. Though not required to practice aspects of the disclosure, these advantages may include a method for providing a context aware suggestion.

Although implementations for methods and systems for providing a context aware suggestion have been described in language specific to structural features and/or methods, it is to be understood that the appended claims are not necessarily limited to the specific features or methods described. Rather, the specific features and methods are disclosed as examples of implementations providing a context aware suggestion.

We claim:

1. A method for providing a context aware suggestion within an organization, the method comprising:
generating, by a processor, one or more hash indexes associated with a primary user based on primary user data;
generating, by the processor, a hash matrix associated to the primary user based on the primary user data, one or more secondary users associated to the primary user data, and the one or more hash indexes, and wherein the hash matrix is a two dimensional matrix;
developing, by the processor, a master list based on the one or more hash indexes;
creating, by the processor, a primary user persona associated to the primary user based on the master list and organization data; and
providing, by the processor, a context aware suggestion within an organization to the primary user in response to a text input from the primary user, wherein the context aware suggestion is based on the primary user persona and the hash matrix.

2. The method of claim 1, further comprising:
obtaining, by the processor, the primary user data and the text input from the primary user, wherein the primary user data comprises a primary user document, a primary user chat transcript, a primary user email, a primary user calendar notification, an primary user notes pointers and a primary user activity data; and
obtaining, by a processor, the organization data, wherein the organization data comprises organizational policies, an organizational structure, an organizational role, organizational responsibilities, a project assignations and a people graph.

3. The method of claim 1, further comprising improving the accuracy of the context aware suggestion based on a machine learning technique.

4. The method of claim 3, wherein the machine learning technique is a semi-supervised machine learning technique.

5. The method of claim 3, wherein the machine learning technique is a reinforcement machine learning technique.

6. The method of claim 1, wherein the master list is developed at a predefined first time interval.

7. The method of claim 1, wherein the user persona is created at a predefined second time interval.

8. A system for providing a context aware suggestion within an organization, the system comprising:
a memory; and
a processor coupled to the memory, wherein the processor is capable of executing instructions to perform steps of:
generating one or more hash indexes associated with a primary user based on primary user data;
generating a hash matrix associated to the primary user based on the primary user data, one or more secondary users associated to the primary user data, and the one or more hash indexes, and wherein the hash matrix is a two dimensional matrix;
developing a master list based on the one or more hash indexes;
creating a primary user persona associated to the primary user based on the master list and organization data; and
providing a context aware suggestion within an organization to the primary user in response to a text input from the primary user, wherein the context aware suggestion is based on the primary user persona and the hash matrix.

9. The system of claim 8, wherein the processor is further capable of executing instructions to perform steps of:
obtaining the primary user data and the text input from the primary user, wherein the primary user data comprises a primary user document, a primary user chat transcript, a primary user email, a primary user calendar notification, an primary user notes pointers and a primary user activity data; and
obtaining the organization data, wherein the organization data comprises organizational policies, an organizational structure, an organizational role, organizational responsibilities, a project assignations and a people graph.

10. The system of claim 8, wherein the processor is further capable of executing instructions to perform steps of:
improving the accuracy of the context aware suggestion based on a machine learning technique.

11. The system of claim 10, wherein the machine learning technique is a semi-supervised machine learning technique.

12. The system of claim 10, wherein the machine learning technique is a reinforcement machine learning technique.

13. The system of claim 8, wherein the master list is developed at a predefined first time interval.

14. The system of claim 8, wherein the user persona is created at a predefined second time interval.

15. A non-transitory computer program product having embodied thereon a computer program for providing a context aware suggestion within an organization, the computer program product storing instructions, the instructions comprising instructions for:
obtaining the primary user data and the text input from the primary user, wherein the primary user data comprises a primary user document, a primary user chat transcript, a primary user email, a primary user calendar notification, an primary user notes pointers and a primary user activity data;
obtaining the organization data, wherein the organization data comprises organizational policies, an organizational structure, an organizational role, organizational responsibilities, a project assignations and a people graph.
generating one or more hash indexes associated with a primary user based on primary user data;
generating a hash matrix associated to the primary user based on the primary user data, one or more secondary users associated to the primary user data, and the one or more hash indexes, and wherein the hash matrix is a two dimensional matrix;
developing a master list based on the one or more hash indexes;
creating a primary user persona associated to the primary user based on the master list and organization data; and
providing a context aware suggestion within an organization to the primary user in response to a text input from the primary user, wherein the context aware suggestion is based on the primary user persona and the hash matrix.

16. A non-transitory computer program product of claim 15, further comprising improving the accuracy of the context aware suggestion based on a machine learning technique.
